(19) United States
(12) Patent Application Publication
(10) Pub. No.: US 2008/0197519 A1
(43) Pub. Date: Aug. 21, 2008

(54) Strand Shaping Part and Method for Starting the Same

(75) Inventors: Helmut Bacher, St. Florian (AT); Helmuth Schulz, Linz (AT); Georg Wendelin, Linz (AT)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Erema Engineering Recycling Maschinen und Anlagen Gesellschaft m.b.H., Ansfelden (AT)

(21) Appl. No.: 11/795,455

(22) PCT Filed: Jan. 12, 2006
(86) PCT No.: PCT/AT06/00013

§ 371 Date: Mar. 17, 2008

(30) Foreign Application Priority Data
Jan. 18, 2005 (AT) A 78/2005

(51) Int. Cl. B29B 9/06

(52) U.S. Cl. 264/14; 425/66

(57) ABSTRACT

A strand shaping part for connecting an extruder (1) to a granulating system has a number of supply channels (8) that can be flow-connected to the outlet (5) of the extruder (1). These supply channels lead to gear pumps (21) which have a delivery behaviour that is as constant as possible and with which the flow of melt to channels (11) can be blocked during start up. A single channel (11) leads from each gear pump (21) to a strand die (9) that can be formed by holes of a perforated plate (10) which is connected to a perforated plate head (7). Several gear pumps (21) are driven by a common shaft (24).

The method for starting a granulating system provided with a strand shaping part of the aforementioned type provides that the extruder (1) is first started until a sufficient pressure is built up at the inlet (27) of each gear pump (21). Once this pressure is reached, each gear pump (21) is started again. In an underwater granulating system, the granulating blades (12) are rotationally driven last (FIG. 1).

The invention relates to a strand shaping part for connecting an extruder to a granulating system, preferably for thermoplastic material, having at least one supply channel that can be flow-connected to the extruder for the melt, which leads to a gear pump with which the flow of melt to a channel that leads to a strand die can be blocked during start up.

Furthermore, the invention relates to a method for starting a granulating system provided with a strand shaping part of this type.

Granulating systems offer the advantage of being able to granulate very low viscous materials, in particular thermoplastic materials, preferably for recycling purposes. In an underwater granulating system, the melt delivered by the extruder directly reaches the granulator housing through which water flows. The cutting tools which pass the perforated plate and thereby divide the strands coming out of the holes of the perforated plate which form the dies into granulated particles also run underwater. On the other hand, in a conventional strand granulating system, the strands coming out of the strand dies are left in a water bath in which the melt solidifies, after which the strands are removed from the water bath and conveyed to the granulating blades.

To be able to start systems of this type, the melt must be promptly supplied to the dies to prevent individual dies from freezing as, in particular in underwater granulating systems in which the perforated plate is in contact with water, the melt cools off quickly. To ensure the aforementioned prompt supply in a strand shaping part having the known construction described above, the part carrying out the blocking is formed by a valve which is opened as soon as the extruder is brought to a full output. Until then, the melt material conveyed by the extruder is, discharged via a lateral outlet, primarily onto the ground. Aside from the noted loss in material, the disadvantage is the fact that irregular throughputs occur at the dies or the holes of the perforated plate, which results in irregular properties of the granulated material produced.

A granulating system is known from U.S. Pat. No. 5,723,082 in which a slide gate is used to block the flow of melt to the dies. This slide gate can also be omitted, in which case the gear pump has to assume the function of the slide gate. The flow of melt to the dies can also be blocked by switching off the gear pump in a construction according to EP 0 894 594 A2, also in a construction according to DE 101 17 913 A1. However, in all of these known constructions, the disadvantage of irregular throughputs on the dies or holes of the perforated plate can also not be satisfactorily overcome.

The object of the invention is to avoid these disadvantages and to improve a construction of the aforementioned type in such a way that at least an almost uniform throughput is ensured at all dies. The invention solves this object in that several gear pumps which each have the same delivery behaviour are driven by a common shaft, wherein a channel from each gear pump leads to a strand die. Therefore, each gear pump is connected by a single channel with the strand die allocated to it. In this way, it is ensured that each gear pump doses the flow of melt to the die allocated to it. Since the gear pumps each have the same delivery behaviour and are driven by the common shaft, this means that each strand die supplied by the respective gear pump is uniformly supplied with a volume of melt per unit of time. Thus, uniform conditions set in for all holes or strand dies, so that a uniform quality of the granulated material produced is ensured. The dimensions of the granulated material are then in a very narrow tolerance zone.

Furthermore, the advantage is offered that, in addition, every gear pump mixes the melt supplied to it by the extruder, so that a further uniformity of the quality of the melt is obtained.

Finally, the advantage is given that, when the gear pump is at a standstill, a preliminary pressure can be built up at the entrance of the gear pump by means of the extruder. If the gear pump is not rotationally driven until said preliminary pressure has been reached, the full flow of mass sets in immediately in the respective channel leading to the die, as a result of which it is prevented that these channels freeze.

To safeguard the advantage that no varying conditions occur at the die outlets, it is advantageous if, within the scope of an embodiment of the invention, each gear pump of the strand die in question is arranged so as to be adjacent, so that the length of the channels leading from the gear pump outlets to the dies is short. In contrast thereto, for the most part, there are large channel lengths between the shutoff valve or the gear pump and the strand dies or the holes of the perforated plate in the known constructions, which results in the noted difficulties. This channel length, which is kept short in accordance with the invention, can be easily realized structurally in that the strand dies are provided on a die carrier which forms a housing for the gear pump. In this case, it is not necessary to form the strand dies from separate components, of course, the die carrier can also be a perforated plate head, whereby the strand dies are formed by holes of a perforated plate fastened to it. Moreover, the use of gear pumps offers the advantage that it is possible to be able to set, optionally, the volume flow by changing the drive of the gear pumps, perhaps differently for individual pumps of several gear pumps, so that melt is discharged uniformly everywhere from the holes.

The method according to the invention for starting a granulating system which is provided with a strand shaping part according to the invention and supplied with melt by an extruder, is characterized in that the extruder is first driven until a sufficient pressure is built up at the entrance of each gear pump, and that each gear pump is not driven from its thusfar stillstand state until this pressure has been attained, whereby, in an underwater granulating system, the granulating blades are rotationally driven last. This method ensures the aforementioned avoidance of the melt freezing in the channels leading to the strand dies or holes of the perforated plate and ensures the uniform quality of the granulated material cut from the individual strands.

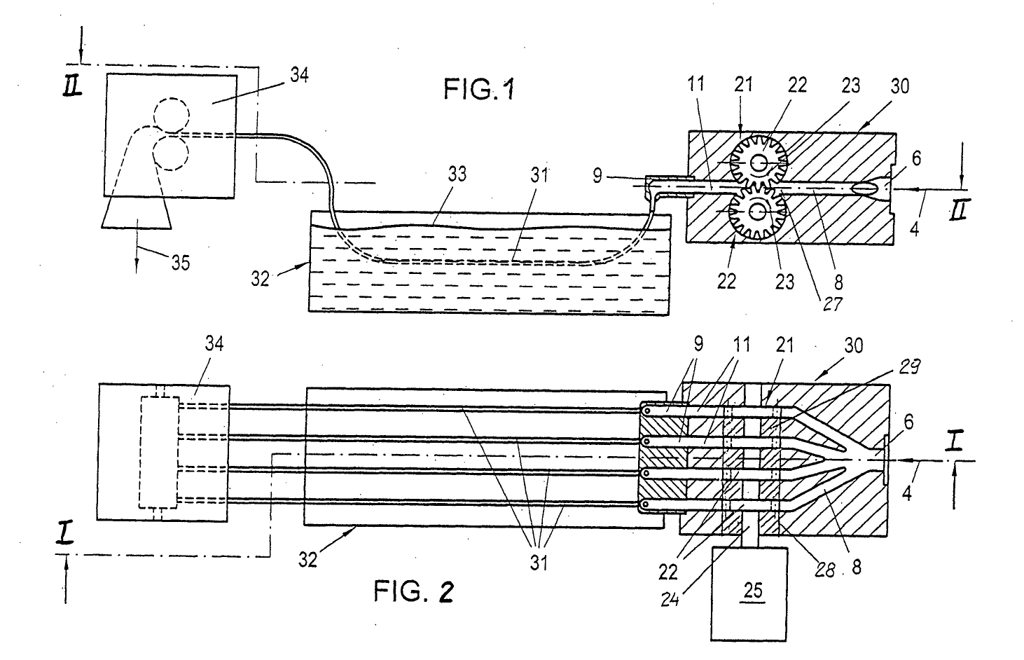

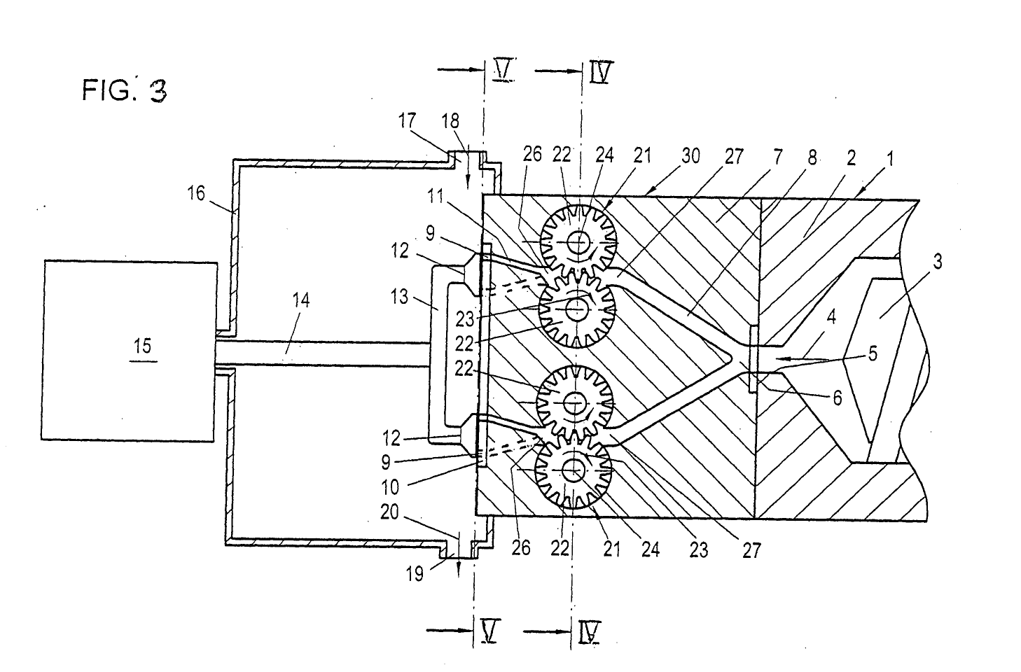

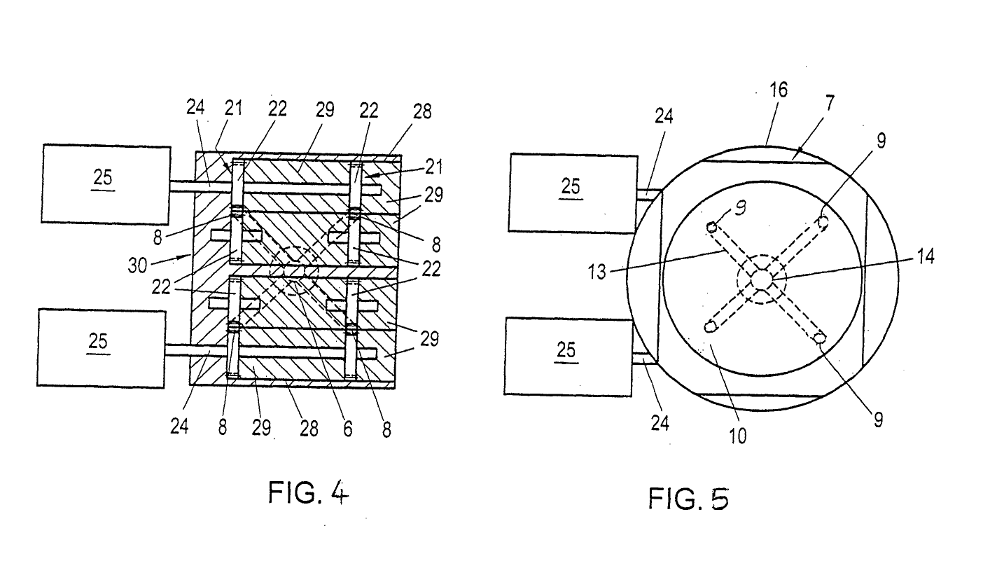

Examples of embodiments of a strand shaping part according to the invention are schematically illustrated in the drawings. FIGS. 1 and 2 show the use of the invention on a strand granulating system, whereby FIG. 1 is a section along the line I-I of FIG. 2 and FIG. 2 is a section along the line II-II of FIG. 1. FIGS. 3 to 5 show the application of the invention to an underwater granulating system, wherein FIG. 3 shows a longitudinal section through the system, while FIG. 4 is a section along the line IV-IV of FIG. 3 and FIG. 5 a section along the line V-V of FIG. 3.

The strand granulating system shown in FIGS. 1 and 2 is supplied by an extruder with the mass to be granulated, in particular, this mass is formed by thermoplastic material which is to be granulated for recycling purposes. The extruder has a worm-gear housing in which a worm driven rotationally about its axis is mounted. The extruder conveys the plasticized material in direction of arrow 4 into an outlet of the worm-gear housing to which the inlet 6 of a die carrier 30 is tightly attached. From this inlet 6, several supply channels 8 convey the melt to the channels 11 which lead to the strand dies 9 fastened to the die carrier 30.

To improve the starting conditions and to ensure uniform quality properties of the granulated particles cut off, each supply channel 8 leads to a gear pump 21 situated in the die carrier 30, said gear pump having a constant delivery behaviour for the material conveyed to it for each specific number of revolutions. The embodiment shown has four gear pumps 21 and, thus, four supply channels 8 and four channels 11. The two gears 22 of each gear pump 21 are rotationally driven in direction of arrow 23. For this purpose, each gear 22 of each gear pump 21 is mounted so as to be secured against rotation on a shaft 24 (FIG. 2) which is driven by a motor 25. The other gear 25 of the respective gear pump 21 is taken along by the actuated gear via the gearing. The gear pumps are driven by a common shaft 24.

A single channel 11 is connected to the outlet 26 of each gear pump 21, as FIGS. 1 and 2 show. This channel 11 leads from the outlet of the respective gear pump 21 to a strand die 9 which is inserted in the die carrier 30 which forms a housing for the gear pump 21.

The outlet of each strand die 9 is directed downward, so that the extruded melt strand 31 coming out of it falls into a strand cooling bath 32 which is filled with water 33. The solidified strands 31 are again removed from this strand cooling bath 32 and conveyed to a granulator 34 (only shown schematically) from which the cut granulated particles fall downward in direction of arrow 35.

As FIGS. 1 and 2 show, the gear pumps 32 are arranged relatively close to the dies 9. The advantage of this is that the channels 11 leading from the outlets of the gear pumps 21 to the dies 9 are short, which substantially contributes to the fact that the melt in these channels 11 is prevented from freezing.

As FIG. 2 shows, the gears 22 of each gear pump 21 are mounted in bores 28 of the perforated plate head 7 and held in the respective axial position in the bore 28 by bushings 29. The shafts 24 pass through these bushings or engage in them. After the shafts have been detached from the motors 25, the gears 22, together with the bushings, can be pulled out of the bores 28 or reinserted into the bores 28 in the opposite direction.

As FIGS. 3 to 5 show, the invention can of course also be applied to underwater granulating systems. As FIG. 3 shows, a system of this type is supplied by an extruder 1 with the mass to be granulated. The extruder 1 has a worm-gear housing 2 in which a worm 3 is mounted which is rotationally driven about its axis. The extruder conveys the plasticized material in direction of arrow 4 into an outlet 5 of the worm-gear housing 2 to which the inlet 6 of a perforated plate head 7 forming a die carrier 30 is tightly connected. From this inlet 6, several supply channels 8 convey the melt to channels 11 which lead to the holes forming the strand dies 9 of a perforated plate 10 fastened to the perforated plate head 7. Granulating blades 12 pass over these holes, said granulating blades 12 being fastened on a star-shaped blade carrier 13 which is rotationally driven by a motor 15 via a shaft 14, so that the granulating blades 12 divide the strands exiting the holes into granulated material. The granulating blades 12, the blade carrier 13 and the shaft 14 are situated inside a granulating housing 16 into which water is continuously let in via an inlet 17 in direction of arrow 18, so that the granulating blades 12 and the perforated plate 10 are continuously rinsed by water. The water runs out of the granulating housing 16 again via an outlet 19 in direction of arrow 20 and thereby takes along the granulated particles cut off by the granulating blades 12.

Each melt channel 8 leads to several gear pumps 21 which are arranged in the perforated plate head 7, each gear pump having a constant delivery behaviour for the material supplied to it for each specific number of rotations. The embodiment shown has four gear pumps 21 which are driven in a similar manner and mounted on drive shafts 24, as was described in association with the embodiment according to FIGS. 1 and 2.

A single channel 11 leads from the outlet 26 of each gear pump 21 to a strand die 9 formed by a hole on the perforated plate 10 (FIG. 5). As can be seen, these strand dies 9 are distributed over the surface of the perforated plate 10, a gear pump 21 being allocated to each of these holes 9. In the embodiment shown, four strand die holes 9 are provided on the perforated plate 10, practical embodiments may have one to twelve holes 9 and, accordingly, a corresponding number of gear pumps 21. As a result, the necessary material flow can be ensured by varying the number of gear pumps 21 and strand dies 9. As FIG. 3 shows, in this embodiment also, the gear pumps 21 are arranged relatively close to the holes 9 of the perforated plate 10, so that the channels 11 leading from the outlets 26 of the gear pumps 21 to the holes 9 of the perforated plate 10 are short, which results in the already noted advantage that the melt in the channels 11 is prevented from freezing.

When starting a system of this type, whether it be an underwater granulating system or a strand granulating system, one proceeds in such a way that the gear pumps 21 are first stopped and, consequently, the material flow between the extruder 1 and the dies 9 is completely blocked. The extruder 1 is then started and conveys the plastic material to be processed into the inlet 6 of the die carrier 30 which simultaneously forms a housing for the gear pumps 21. As a result, a pressure in the plastic material supplied builds up at the inlet 27 of each gear pump 21. As soon as this pressure has reached a preset value, which can be monitored by pressure sensors (not shown), all gear pumps 21 are promptly started and thus convey the plastic material supplied to them with constant delivery behaviour into the channels 11 to the dies/dies 9.

Throughput capacities of 20 to 60 kg per hour and per hole of the perforated plate can be obtained with a granulating system designed according to the invention, which signifies an increase of the maximum throughput capacity in comparison to known constructions.

1. A strand shaping part for connecting an extruder (1) to a granulating system, preferably for thermoplastic material, having at least one supply channel (8) for the melt that can be flow-connected with the extruder (1) which leads to a gear pump (21) with which the flow of melt to a channel (11), which leads to a strand die (9), can be blocked during start up, characterized in that there are several gear pumps (21) that each have the same delivery behaviour and whose drive gears (22) are mounted on a common drive shaft (24) so as to be rotationally immovable and are driven by this common drive shaft (24), wherein a single channel (11) leads from each gear pump (21) to a strand die (9).

2. The strand shaping part according to claim 1, characterized in that each gear pump (21) is arranged adjacent to the respective strand die (9), so that the length of the channels (11) is as short as possible.

3. The strand shaping part according to claim 1, characterized in that the strand dies (9) are provided on a die carrier (30) which forms a housing for the gear pumps (21).

4. The strand shaping part according to claim 3, characterized in that the die carrier (30) is a perforated plate head and the strand dies (9) are formed by holes of a perforated plate fastened to it.

5. The strand shaping part according to claim 3, characterized in that the gears (22) of each gear pump (21) are situated in bores (28) of the die carrier (30) and are each secured in their axial position in the respective bore (28) by means of at least one bushing (29), wherein at least one bushing (29) is passed through by a drive shaft (24) for the gears (22).

6. A method for starting a granulating system which is supplied with melt by an extruder (1) via at least one supply channel (8), said supple channel (8) leading to a gear pump (21) with which the flow of melt to a channel (11) that leads to a strang die (9) can be blocked when the extruder is started, characterized in that the extruder (1) is first driven until a sufficient pressure is built up at the inlet (27) of each gear pump (21) which each have the same delivery behaviour and that the drive gears (22) of the gear pumps (21) are not driven from their thusfar standstill state via a common drive shaft (24) until this pressure has been attained.

7. The strand shaping part according to claim 1, characterized in that several supply channels (8) lead the melt from an inlet (6) to the gear pumps (21).

8. The method according to claim 6, characterized in that, in an underwater granulating system, the granulating blades (12) are rotationally driven at the latest when the drive gears (22) of the gear pumps (21) are driven from their thusfar standstill state.
